(19) United States
(12) Patent Application Publication
(10) Pub. No.: US 2019/0146779 A1
(43) Pub. Date: May 16, 2019

(54) VEHICLE-MOUNTED POWER SUPPLY SYSTEM, RELAY BOX, AND RELAY CONTROL APPARATUS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Hiromichi YASUNORI, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/300,401

(22) PCT Filed: Dec. 1, 2017
(86) PCT No.: PCT/JP2017/043292

§ 371 Date: Nov. 9, 2018

(30) Foreign Application Priority Data
Dec. 13, 2016 (JP) 2016-241207

(51) Int. Cl. G06F 8/654; B60R 16/03

(52) U.S. Cl. CPC G06F 8/654; H02G 3/08; B60R 16/03

(57) ABSTRACT

A vehicle-mounted power supply system, a relay box, and a relay control apparatus that, when carrying out an updating process for a vehicle-mounted device, can suppress operations of vehicle-mounted devices not subject to the updating process. The system includes: a vehicle-mounted updating apparatus that carries out a process of updating a program or data stored in a storage unit of a vehicle-mounted device; one or more of a first type of relay disposed in a power supply path from a power supply source to a vehicle-mounted device not subject to the updating process; one or more of a second type of relay disposed in a power supply path from the power supply source to one or more vehicle-mounted devices that can be subject to the updating process; and a relay control apparatus that controls switching of the first type of relay and the second type of relay on/off.

### TECHNICAL FIELD

The present disclosure relates to a vehicle-mounted power supply system that supplies power from a power supply source mounted in a vehicle to a vehicle-mounted device, and relates also to a relay box and a relay control apparatus.

### BACKGROUND ART

Conventionally, a plurality of vehicle-mounted devices such as ECUs (Electronic Control Units) are mounted in a vehicle, and the plurality of ECUs are connected over a communication line such as a CAN (Controller Area Network) so as to be capable of exchanging information with each other. Each ECU carries out various types of processing, such as controlling the vehicle, by a processing device such as a CPU (Central Processing Unit) reading out and executing programs stored in a storage unit such as Flash memory, EEPROM (Electrically Erasable Programmable Read Only Memory), or the like. When it is necessary to add functions, fix problems, upgrade versions, or the like, for example, an updating process must be carried out to overwrite programs or data stored in the storage unit of the ECU with new programs or data. In this case, programs or data for the update are sent over the communication line to the ECU subject to the updating process.

Patent Document 1 proposes an electronic control apparatus including a continual-use microcomputer to which power is supplied continually and a noncontinual-use microcomputer to/from which power is supplied/cut off through user operations. If a change in the power source state of the noncontinual-use microcomputer is detected while control software is being overwritten in a reprogramming mode, the apparatus determines whether the continual-use microcomputer is to operate in an on-board mode or the reprogramming mode.

### CITATION LIST

### Patent Documents

Patent Document 1: JP 2015-102964A

### SUMMARY

### Technical Problem

It is desirable that the updating process for programs or data of an ECU be carried out while the engine is not running and a user is unlikely to be using the vehicle. When carrying out an updating process for programs or data while the engine is not running, the ECU to be updated must be run using power stored in the vehicle battery. As such, if the ECU to be updated is connected to the battery via an IG (ignition) relay or an ACC (accessory) relay, for example, control is carried out to switch the relay on when updating the programs. Controlling the on-state of the relay in this manner means that battery power is supplied to ECUs connected to that relay, even if those ECUs are not subject to the updating process. There is thus a risk that the electrical equipment will consume power during the updating process and the battery will die. There is also a risk of devices such as meters being lighted in vehicles where no occupants are present.

Having been achieved in light of such circumstances, an object of certain aspects of disclosed embodiments is to provide a vehicle-mounted power supply system, a relay box, and a relay control apparatus that, when carrying out an updating process for a vehicle-mounted device, can suppress operations of vehicle-mounted devices not subject to the updating process.

### Solution to Problem

A vehicle-mounted power supply system according to a preferred embodiment includes: a vehicle-mounted updating apparatus that carries out a process of updating a program or data stored in a storage unit of a vehicle-mounted device mounted in a vehicle; one or more of a first type of relay disposed in a power supply path from a power supply source mounted in the vehicle to one or more vehicle-mounted devices not subject to the updating process by the vehicle-mounted updating apparatus; one or more of a second type of relay disposed in a power supply path from the power supply source to one or more vehicle-mounted devices that can be subject to the updating process by the vehicle-mounted updating apparatus; and a relay control apparatus that controls switching of the first type of relay and the second type of relay on/off, wherein when the vehicle-mounted updating apparatus is to carry out the updating process, the relay control apparatus: turns the first type of relay off, turns on, of the one or more of the second type of relay, a second type of relay disposed in a power supply path to a vehicle-mounted device subject to the updating process; and turns off, of the one or more of the second type of relay, a second type of relay disposed in a power supply path to a vehicle-mounted device not subject to the updating process.

A vehicle-mounted power supply system according to a preferred embodiment includes: a vehicle-mounted updating apparatus that carries out a process of updating a program or data stored in a storage unit of a vehicle-mounted device mounted in a vehicle; one or more of a first type of relay disposed in a power supply path from a power supply source mounted in the vehicle to a plurality of the vehicle-mounted devices; one or more of a second type of relay disposed in a power supply path from the first type of relay to one or more vehicle-mounted devices that are not subject to the updating process by the vehicle-mounted updating apparatus; and a relay control apparatus that controls switching of the first type of relay and the second type of relay on/off, wherein when the vehicle-mounted updating apparatus is to carry out the updating process, the relay control apparatus turns the first type of relay on, and turns the second type of relay off.

The vehicle-mounted power supply system according to a preferred embodiment further includes a relay box containing the first type of relay and the second type of relay.

In the vehicle-mounted power supply system according to a preferred embodiment, the relay box includes: a communication unit that communicates with the relay control apparatus; and a control signal output unit that, in response to a control command received by the communication unit from the relay control apparatus, outputs a control signal turning the first type of relay and the second type of relay on/off.

A relay box according to a preferred embodiment includes: one or more relays disposed in a power supply path from a power supply source mounted in a vehicle to a plurality of vehicle-mounted devices; a communication unit that communicates with another apparatus mounted in the vehicle; and a control signal output unit that, in response to a control command received by the communication unit from the other apparatus, outputs a control signal turning the relays on/off.

A relay box according to a preferred embodiment includes: one or more of a first type of relay disposed in a power supply path from a power supply source mounted in a vehicle to a plurality of vehicle-mounted devices; and one or more of a second type of relay disposed in a power supply path from the first type of relay to some of the plurality of vehicle-mounted devices.

The relay box according to a preferred embodiment further includes: a communication unit that communicates with another apparatus mounted in the vehicle; and a control signal output unit that, in response to a control command received by the communication unit from the other apparatus, outputs a control signal turning the first type of relay and the second type of relay on/off.

A relay control apparatus according to a preferred embodiment includes: a relay control unit that controls switching one or more of a first type of relay and one or more of a second type of relay on/off, the first type of relay being disposed in a power supply path from a power supply source mounted in a vehicle to a vehicle-mounted device, among a plurality of vehicle-mounted devices, that is not subject to an updating process, and the second type of relay being disposed in a power supply path from the power supply source to one or more vehicle-mounted devices, among the plurality of vehicle-mounted devices, that can be subject to the updating process, wherein when the updating process is to be carried out, the relay control unit: turns the first type of relay off, turns on, of the one or more of the second type of relay, a second type of relay disposed in a power supply path to a vehicle-mounted device subject to the updating process; and turns off, of the one or more of the second type of relay, a second type of relay disposed in a power supply path to a vehicle-mounted device not subject to the updating process.

A relay control apparatus according to a preferred embodiment includes: a relay control unit that controls switching one or more of a first type of relay and one or more of a second type of relay on/off, the first type of relay being disposed in a power supply path from a power supply source mounted in a vehicle to a plurality of vehicle-mounted devices, and the second type of relay being disposed in a power supply path from the first type of relay to one or more vehicle-mounted devices, among the plurality of vehicle-mounted devices, that are not subject to an updating process, wherein when the updating process is to be carried out, the relay control unit: turns the first type of relay on; and turns the second type of relay off.

According to some disclosed embodiments, the one or more of the first type of relay is provided in a power supply path from the power supply source of the vehicle to a vehicle-mounted device not subject to the updating process, and the one or more of the second type of relay is provided in a power supply path from the power supply source to a vehicle-mounted device that can be subject to the updating process. When the vehicle-mounted updating apparatus carries out the process of updating a program or data stored in the storage unit of one of the vehicle-mounted devices, the relay control apparatus turns the first type of relay off to stop the supply of power to the vehicle-mounted device not subject to the updating process. In this case, of the one or more of the second type of relay, the relay control apparatus turns on the second type of relay disposed in the power supply path to the vehicle-mounted device subject to the updating process, and turns off the second type of relay disposed in the power supply path to the vehicle-mounted device not subject to the updating process. This makes it possible to suppress a situation in which power is supplied to vehicle-mounted devices that are not subject to the updating process.

Additionally, according to some disclosed embodiments, the one or more of the first type of relay is provided in a power supply path from the power supply source of the vehicle to a vehicle-mounted device, and the one or more of the second type of relay is provided in a power supply path from the first type of relay to a vehicle-mounted device not subject to the updating process. When the vehicle-mounted updating apparatus carries out the process of updating a program or data stored in the storage unit of one of the vehicle-mounted devices, the relay control apparatus turns the first type of relay on and turns the second type of relay off. This makes it possible to suppress a situation in which power is supplied to vehicle-mounted devices that are not subject to the updating process.

A preferred embodiment includes a relay box containing one or more of the first type of relay and one or more of the second type of relay. The relay box communicates with the relay control apparatus, and in response to a control command from the relay control apparatus, switches the first type of relay and the second type of relay on/off. For example, if the configuration is such that the relay control apparatus outputs control signals for controlling the relays, an increase in the number of relays will result in an increase in the number of signal lines from the relay control apparatus to the relays. By employing a configuration in which the relay control apparatus and the relay box communicate, and the relay control apparatus switches the relays on the basis of the communication, it is only necessary to provide a communication line between the relay control apparatus and the relay box. This makes it possible to suppress an increase in the number of signal lines resulting from an increase in the number of relays.

### Advantageous Effects

According to aspects of some disclosed embodiments, relays are provided as appropriate in power supply paths from a power supply source to vehicle-mounted devices, and the relays are turned on/off as appropriate when carrying out an updating process. Accordingly, the supply of power to vehicle-mounted devices not subject to the updating process can be stopped, and those vehicle-mounted devices can be prevented from operating.

### BRIEF DESCRIPTION OF DRAWINGS

FIG. 1 is a block diagram illustrating the configuration of a vehicle-mounted power supply system according to a first embodiment.

FIG. 2 is a schematic diagram illustrating switching control of each of relays in a relay box by a BCM.

FIG. 3 is a block diagram illustrating the configuration of a BCM.

FIG. 4 is a flowchart illustrating a relay switching control processing sequence carried out by the BCM.

FIG. 5 is a block diagram illustrating the configuration of a vehicle-mounted power supply system according to a variation on the first embodiment.

FIG. 6 is a block diagram illustrating the configuration of a vehicle-mounted power supply system according to a second embodiment.

FIG. 7 is a schematic diagram illustrating switching control of each of relays in a relay box by a BCM, according to the second embodiment.

FIG. 8 is a flowchart illustrating a relay switching control processing sequence carried out by the BCM, according to the second embodiment.

### DESCRIPTION OF EMBODIMENTS

### First Embodiment

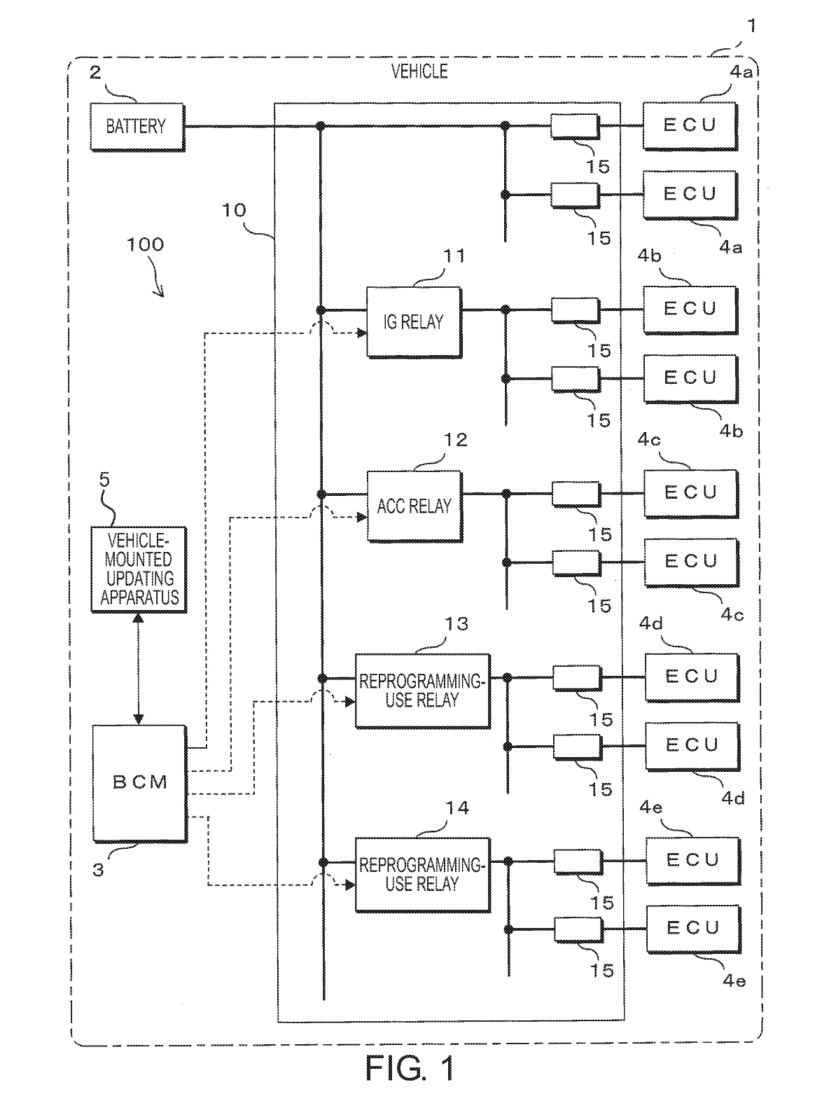

FIG. 1 is a block diagram illustrating the configuration of a vehicle-mounted power supply system 100 according to a first embodiment. The vehicle-mounted power supply system 100 according to the present embodiment is configured with a relay box 10 provided in a power supply path from a battery 2, which is a power supply source mounted in a vehicle 1, to a plurality of ECUs 4a, 4b, 4c, 4d, and 4e. The relay box 10 contains a plurality of relays, and can switch between supplying and not supplying power from the battery 2 to the ECUs 4a, 4b, 4c, 4d, and 4e by switching the relays on/off. The relay box 10 includes a single power input terminal, which is connected to the battery 2 by a power line and into which power supplied from the battery 2 is input. The relay box 10 also includes a plurality of power output terminals, which are connected to corresponding ones of the ECUs 4a, 4b, 4c, 4d, and 4e by power lines.

In the first embodiment, the relay box 10 includes four relays, namely an IG relay 11, an ACC relay 12, and reprogramming-use relays 13 and 14. Control for switching these four relays on/off is carried out by a BCM (Body Control Module) 3 mounted in the vehicle 1. As such, the BCM 3 outputs four control signals for controlling the switching of the four relays, and four signal lines for transmitting the control signals are provided between the BCM 3 and the relay box 10. The relay box 10 includes four control signal input terminals to which the four signal lines are connected.

In the present embodiment, the ECUs 4a, 4b, 4c, 4d, and 4e mounted in the vehicle 1 can be classified into five types. The ECUs 4a are ECUs to which power is supplied from the battery 2 continually, without control for switching on/off by a relay. The ECUs 4b are ECUs to which the supply of power is switched on/off by the IG relay 11 turning on/off. The ECUs 4c are ECUs to which the supply of power is switched on/off by the ACC relay 12 turning on/off. The ECUs 4d are ECUs to which the supply of power is switched on/off by the reprogramming-use relay 13 turning on/off. The ECUs 4e are ECUs to which the supply of power is switched on/off by the reprogramming-use relay 14 turning on/off.

The power supply path from the power input terminal of the relay box 10, into which power from the battery 2 is input, to the power output terminals to which the ECUs 4a, 4b, 4c, 4d, and 4e are individually connected via power lines, branch into a plurality of paths within the relay box 10. A fuse 15 is provided in each of the power supply paths from the power input terminal to the plurality of power output terminals to which the ECUs 4a are connected. The fuse 15 is a protective element that protects the ECU 4a connected thereafter by blowing and cutting off the power supply path when a predetermined or greater amount of current flows in the fuse 15.

The power supply path from the power input terminal of the relay box 10 further branches into four paths. The resulting four power supply paths are connected to the IG relay 11, the ACC relay 12, the reprogramming-use relay 13, and the reprogramming-use relay 14, respectively. The power supply path from the IG relay 11 branches into a plurality of paths. The resulting plurality of power supply paths extend to a corresponding plurality of power output terminals through fuses 15, and the ECUs 4b are connected to corresponding ones of those power output terminals. Likewise, the power supply path from the ACC relay 12 branches into a plurality of paths. The resulting plurality of power supply paths extend to a corresponding plurality of power output terminals through fuses 15, and the ECUs 4c are connected to corresponding ones of those power output terminals. The power supply path from the reprogramming-use relay 13 branches into a plurality of paths. The resulting plurality of power supply paths extend to a corresponding plurality of power output terminals through fuses 15, and the ECUs 4d are connected to corresponding ones of those power output terminals. The power supply path from the reprogramming-use relay 14 branches into a plurality of paths. The resulting plurality of power supply paths extend to a corresponding plurality of power output terminals through fuses 15, and the ECUs 4e are connected to corresponding ones of those power output terminals.

In the present embodiment, the ECUs 4d and 4e are ECUs that can be subject to what is known as reprogramming, which is a function for automatically carrying out a process for updating programs or data stored in memory. The ECUs 4a to which power is continually supplied may also be subject to reprogramming. In the present embodiment, a vehicle-mounted updating apparatus 5 mounted in the vehicle 1 carries out the process for updating the programs or data of the ECUs 4d and 4e. Although not illustrated, the vehicle-mounted updating apparatus 5 can communicate with the ECUs 4d and 4e over an in-vehicle network such as a CAN. The vehicle-mounted updating apparatus 5 can be realized as, for example, a gateway apparatus, a wireless communication apparatus, or the like installed in the vehicle 1. After obtaining the update programs or data from a server device or the like outside the vehicle, the vehicle-mounted updating apparatus 5 sends the update programs or data, obtained from the server device, to the ECUs 4d and 4e over the in-vehicle network, while the engine of the vehicle 1 is not running, for example. Having received the update programs or data from the vehicle-mounted updating apparatus 5, the ECUs 4d and 4e can update the programs or data by overwriting memory in the ECUs 4d and 4e.

However, in the present embodiment, the updating process is carried out in a state where the vehicle 1 is not traveling or is not being used, such as when the engine of the vehicle 1 is not running. To carry out the updating process, it is necessary to supply power to the ECUs subject to the updating process. The vehicle-mounted updating apparatus 5 and the BCM 3 can communicate over an in-vehicle network such as a CAN. When carrying out the updating process, the vehicle-mounted updating apparatus 5 notifies the BCM 3 of which ECUs are to be updated. In response to the notification from the vehicle-mounted updating apparatus 5, the BCM 3 switches the reprogramming-use relay 13 and/or the reprogramming-use relay 14 on to supply power to the ECUs to be updated.

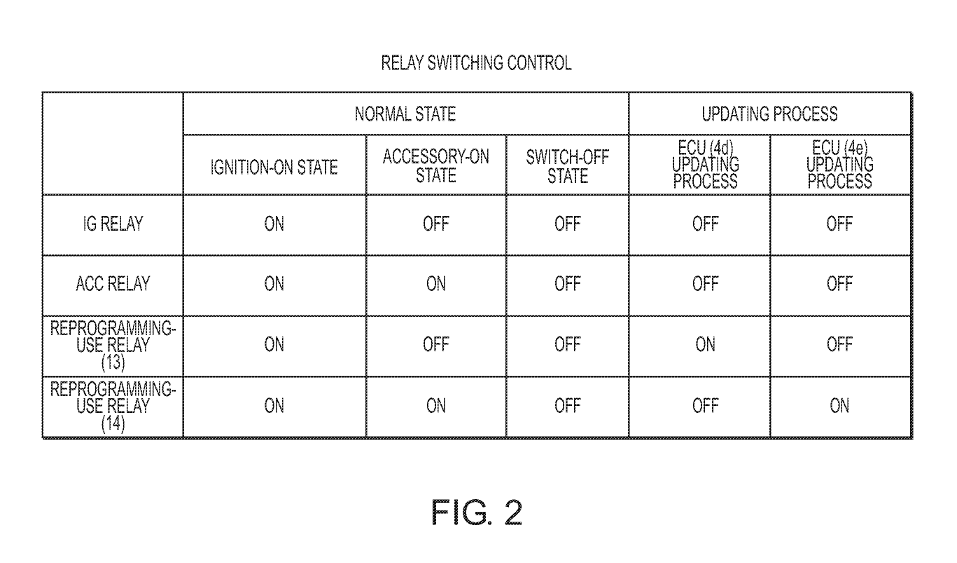

FIG. 2 is a schematic diagram illustrating switching control of each of relays in the relay box 10 by the BCM 3. In a normal state, when the updating process is not underway, the BCM 3 controls the on/off states of the relays in the relay box 10 in response to the ignition switch of the vehicle 1 being operated, for example. In the present embodiment, the ignition switch can be switched by a user among three states: an ignition-on state, which is a state in which the engine of the vehicle 1 is running and the vehicle 1 can travel; an accessory-on state, which is a state in which the vehicle 1 cannot travel but predetermined vehicle-mounted devices can be used; and a switched-off state, which is a state in which the operations of the vehicle-mounted devices are stopped, such as when the vehicle 1 is parked.

In the ignition-on state, the BCM 3 switches the IG relay 11, the ACC relay 12, the reprogramming-use relay 13, and the reprogramming-use relay 14 in the relay box 10 all on. As a result, power is supplied to all of the ECUs 4a, 4b, 4c, 4d, and 4e from the battery 2 (or an alternator that supplies power to the battery 2, or the like). In the accessory-on state, the BCM 3 turns the IG relay 11 and the reprogramming-use relay 13 in the relay box 10 off, and turns the ACC relay 12 and the reprogramming-use relay 14 on. Power is supplied to the ECUs 4a, 4c, and 4e from the battery 2 as a result. In the switched-off state, the BCM 3 switches the IG relay 11, the ACC relay 12, the reprogramming-use relay 13, and the reprogramming-use relay 14 all off. As a result, power is supplied from the battery 2 only to the ECUs 4a, and the supply of power to the ECUs 4b, 4c, 4d, and 4e is stopped.

When carrying out the updating process, the vehicle-mounted updating apparatus 5 communicates to the BCM 3 which of the ECUs is subject to the updating process. If the ECUs 4d are subject to the updating process, the BCM 3 turns on only the reprogramming-use relay 13 to which the ECUs 4d are connected, and turns the other relays off. Likewise, if the ECUs 4e are subject to the updating process, the BCM 3 turns on only the reprogramming-use relay 14 to which the ECUs 4e are connected, and turns the other relays off. After the BCM 3 finishes switching the relays, the vehicle-mounted updating apparatus 5 sends the update programs or data over the in-vehicle network to the ECUs 4d or 4e subject to the updating process. Having received the update programs or data from the vehicle-mounted updating apparatus 5, the ECUs 4d or 4e update the programs or data by writing the received programs or data into the memory of the ECUs 4d or 4e. Once the updating process is complete for the ECUs 4d or 4e, the vehicle-mounted updating apparatus 5 notifies the BCM 3 that the updating process is complete. In response to this notification, the BCM 3 switches off the reprogramming-use relay 13 or 14, which had been on.

In other words, in the normal state, where the updating process is not underway, the reprogramming-use relay 13 is subject to the same switching control as the IG relay 11, and the reprogramming-use relay 14 is subject to the same switching control as the ACC relay 12. When, however, the updating process is to be carried out, switching control is carried out so that only the reprogramming-use relay 13 or 14, to which the ECUs 4d or 4e subject to the updating process are connected, are turned on, and the other relays are turned off.

That is, assume that in a conventional vehicle, of the ECUs connected to the IG relay 11, ECUs that may be subject to an updating process are connected to the reprogramming-use relay 13 as the ECUs 4d, and of the ECUs connected to the ACC relay 12, ECUs that may be subject to an updating process are connected to the reprogramming-use relay 14 as the ECUs 4e. This configuration corresponds to the vehicle-mounted power supply system 100 according to the first embodiment.

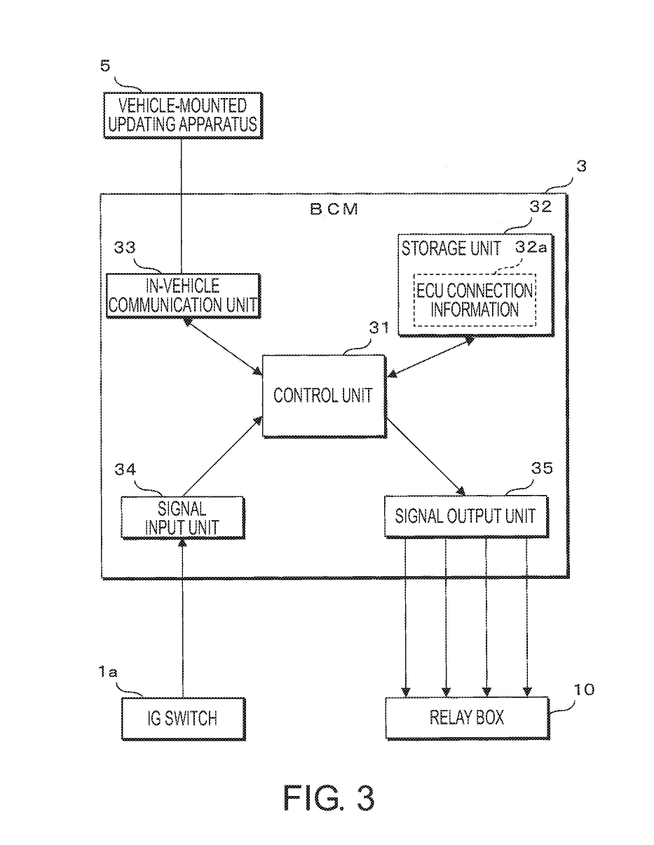

FIG. 3 is a block diagram illustrating the configuration of the BCM 3. The BCM 3 according to the present embodiment is configured including a control unit 31, a storage unit 32, an in-vehicle communication unit 33, a signal input unit 34, and a signal output unit 35. The control unit 31 is configured using a computational processing device such as a CPU (Central Processing Unit), an MPU (Micro-Processing Unit), or the like, and carries out processing for controlling the body system of the vehicle 1 by reading out and executing programs (not shown) stored in the storage unit 32. The control unit 31 may be configured to carry out processes for controlling the locking/unlocking of the doors of the vehicle 1, opening/closing windows, and/or lighting/extinguishing lamps, for example. The BCM 3 according to the present embodiment carries out a control process for switching the relays in the relay box 10 on/off.

The storage unit 32 is configured using a non-volatile memory device such as EEPROM (Electrically Erasable Programmable Read Only Memory), Flash memory, or the like. The storage unit 32 stores programs executed by the control unit 31, data required for processing performed by the control unit 31, and so on. In the present embodiment, the storage unit 32 stores, as ECU connection information 32a, information pertaining to the relays to which the ECUs subject to the updating process are connected.

The in-vehicle communication unit 33 is connected to a communication line constituting the in-vehicle network, and exchanges information with other vehicle-mounted devices by communicating over the communication line through a communication protocol such as CAN. In the present embodiment, the in-vehicle communication unit 33 communicates with the vehicle-mounted updating apparatus 5. Note that the in-vehicle communication unit 33 may be configured to communicate one-to-one with the vehicle-mounted updating apparatus 5. The in-vehicle communication unit 33 sends information to the vehicle-mounted updating apparatus 5 by outputting transmission information provided by the control unit 31 to the communication line as an electrical signal. The in-vehicle communication unit 33 receives information from the vehicle-mounted updating apparatus 5 by sampling a potential of the communication line, and supplies the received information to the control unit 31.

One or more signal lines are connected to the signal input unit 34. The signal input unit 34 samples a signal input directly to the BCM 3 without going through the in-vehicle network, and supplies the obtained input signal state to the control unit 31. In the present embodiment, a signal indicating a switching state of an IG (ignition) switch 1a provided in the vehicle 1 is inputted to the signal input unit 34 of the BCM 3. The signal input from the IG switch 1a indicates whether the IG switch 1a is switched to the ignition-on state, the accessory-on state, or the switched-off state. The signal input unit 34 obtains the input signal from the IG switch 1a and notifies the control unit 31 whether the IG switch 1a is switched to the ignition-on state, the accessory-on state, or the switched-off state.

The signal output unit 35 is connected to the relay box 10 by a plurality of signal lines, and outputs control signals that switch the plurality of relays in the relay box 10 on/off. In the present embodiment, the signal output unit 35 outputs four control signals that individually switch the IG relay 11, the ACC relay 12, the reprogramming-use relay 13, and the reprogramming-use relay 14 on/off. The signal output unit 35 sets the values of the four control signals, and outputs those signals, in accordance with commands from the control unit 31.

In the normal state, in which the updating process by the vehicle-mounted updating apparatus 5 is not underway, the control unit 31 of the BCM 3 carries out a process for outputting, from the signal output unit 35, the control signals that switch the relays in the relay box 10 on/off, in accordance with the signal from the IG switch 1a input to the signal input unit 34. When the vehicle-mounted updating apparatus 5 carries out the updating process, the control unit 31 of the BCM 3 receives, from the vehicle-mounted updating apparatus 5, a notification of the ECUs subject to the updating process, through the in-vehicle communication unit 33. The control unit 31 then determines which relays the ECUs notified as subject to updating are connected to, on the basis of the ECU connection information 32a stored in the storage unit 32. The control unit 31 then outputs, from the signal output unit 35, control signals that turn on only the relays to which the ECUs subject to updating are connected.

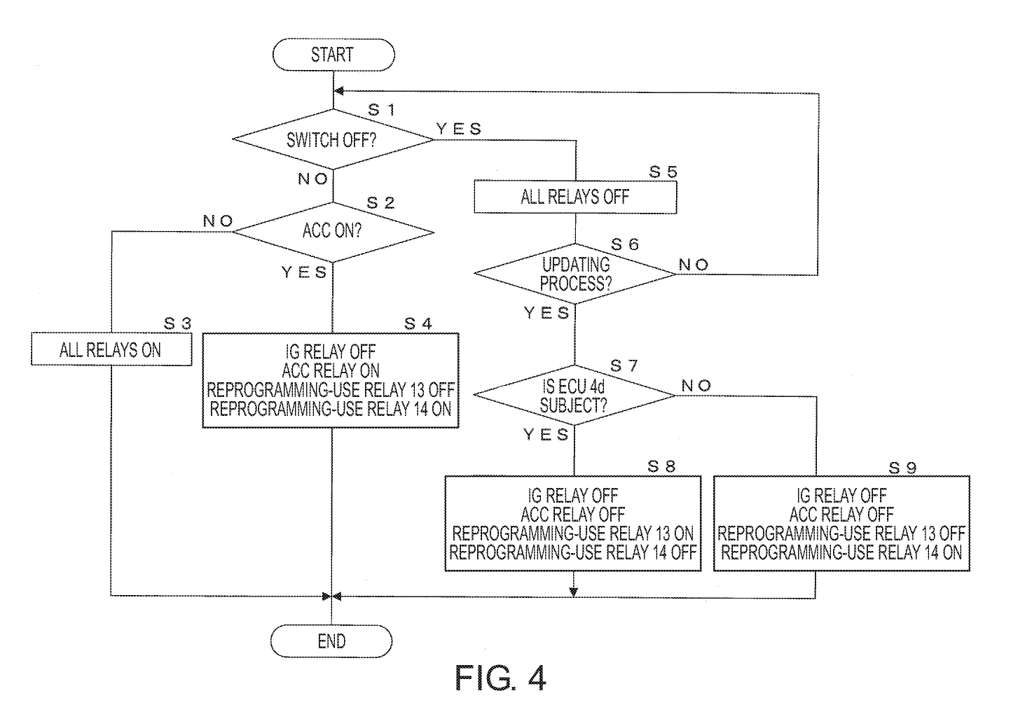

FIG. 4 is a flowchart illustrating a relay switching control processing sequence carried out by the BCM 3. The control unit 31 of the BCM 3 determines whether or not the IG switch 1a is in the switched-off state on the basis of the state of the IG switch 1a supplied from the signal input unit 34 (step S1). If the IG switch 1a is not in the switched-off state (S1: NO), the control unit 31 furthermore determines whether or not the IG switch 1a is in the accessory-on state (step S2). If the IG switch 1a is not in the accessory-on state (S2: NO), i.e., if the IG switch 1a is in the ignition-on state, the control unit 31 outputs, from the signal output unit 35, control signals turning on each of the IG relay 11, the ACC relay 12, the reprogramming-use relay 13, and the reprogramming-use relay 14 in the relay box 10 (step S3), after which the process ends. If the IG switch 1a is in the accessory-on state (S2: YES), the control unit 31 outputs, from the signal output unit 35, control signals that turn the IG relay 11 off, turn the ACC relay 12 on, turn the reprogramming-use relay 13 off, and turn the reprogramming-use relay 14 on (step S4), after which the process ends.

If the IG switch 1a is in the switched-off state (S1: YES), the control unit 31 outputs, from the signal output unit 35, control signals turning off each of the IG relay 11, the ACC relay 12, the reprogramming-use relay 13, and the reprogramming-use relay 14 in the relay box 10 (step S5). The control unit 31 determines whether or not the updating process is to be carried out in accordance with whether or not the in-vehicle communication unit 33 has received, from the vehicle-mounted updating apparatus 5, a notification that the updating process is to be carried out (step S6). If the updating process is not to be carried out (S6: NO), the control unit 31 returns the process to step S1.

If the updating process is to be carried out (S6: YES), the control unit 31 determines whether it is the ECUs 4d that are subject to the updating process, in accordance with an updating subject notification supplied from the vehicle-mounted updating apparatus 5 (step S7). If it is the ECUs 4d that are subject to the updating process (S7: YES), the control unit 31 outputs, from the signal output unit 35, control signals that turn the IG relay 11 and the ACC relay 12 off, turn the reprogramming-use relay 13 on, and turn the reprogramming-use relay 14 off (step S8), after which the process ends. If it is not the ECUs 4d that are subject to the updating process (S7: NO), i.e., if it is the ECUs 4e that are subject to the updating process, the control unit 31 outputs, from the signal output unit 35, control signals that turn the IG relay 11 and the ACC relay 12 off, turn the reprogramming-use relay 13 off, and turn the reprogramming-use relay 14 on (step S9), after which the process ends.

The vehicle-mounted power supply system 100 according to the first embodiment configured as described above includes the IG relay 11 or the ACC relay 12 in the power supply path from the battery 2 of the vehicle 1 to the ECUs 4b or 4c, which are not subject to the updating process, and includes the reprogramming-use relay 13 or 14 in the power supply path from the battery 2 to the ECUs 4d or 4e, which can be subject to the updating process. When the vehicle-mounted updating apparatus 5 carries out the process for updating programs or data stored in the storage unit of the ECUs 4d or 4e, the BCM 3 turns the IG relay 11 and the ACC relay 12 off to stop the supply of power to the ECUs 4b and 4c, which are not subject to the updating process. Additionally, of the reprogramming-use relays 13 and 14, the BCM 3 turns on the reprogramming-use relay 13 or 14 disposed in the power supply path to the ECUs 4d or 4e that are subject to the updating process, and turns off the reprogramming-use relay 13 or 14 disposed in the power supply path to the ECUs 4d or 4e that are not subject to the updating process. This makes it possible to suppress a situation in which power is supplied to the ECUs 4b to 4e that are not subject to the updating process, and suppress unnecessary operations during the updating process.

Although the present embodiment describes a configuration in which four relays, namely the IG relay 11, the ACC relay 12, the reprogramming-use relay 13, and the reprogramming-use relay 14, are provided in the relay box 10, the embodiment is not limited thereto. The configuration may be such that three or fewer, or five or more, relays are provided in the relay box 10. If five or more relays are provided, for example, a plurality of ECUs to be updated together may be taken as a single group, and a single relay may be connected thereto. Alternatively, a single relay may be provided for a single corresponding ECU that can be subject to the updating process. These relays may be switched on/off in tandem with the IG relay 11 or the ACC relay 12 in the normal state, where the updating process is not carried out.

Variation

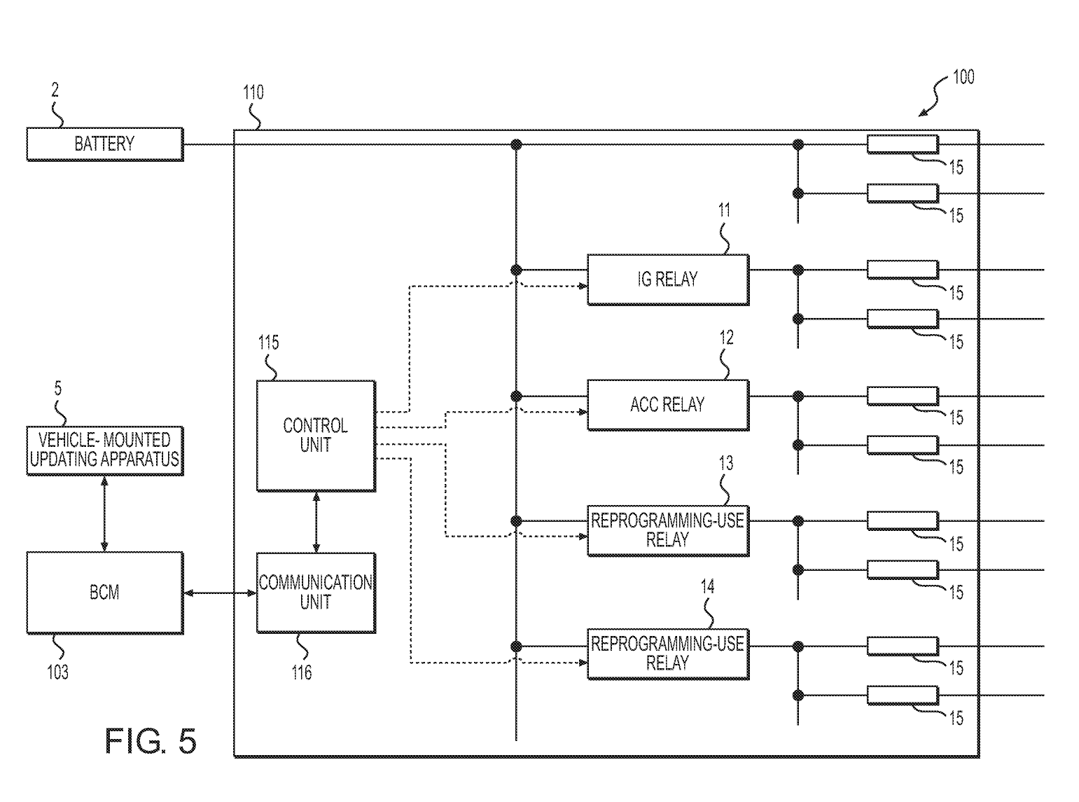

FIG. 5 is a block diagram illustrating the configuration of the vehicle-mounted power supply system 100 according to a variation on the first embodiment. According to the first embodiment described above, the vehicle-mounted power supply system 100 is configured so that the BCM 3 outputs control signals that switch the relays in the relay box 10 on/off. However, the configuration is not limited thereto. In the vehicle-mounted power supply system 100 according to this variation, a BCM 103 and a relay box 110 are capable of communication, and through this communication, the BCM 103 supplies switching commands to the relays in the relay box 110.

The relay box 110 according to this variation includes a control unit 115 and a communication unit 116. The communication unit 116 is connected to the BCM 103 by a communication line, and communicates according to a communication protocol such as LIN (Local Interconnect Network), for example. Although not shown, the BCM 103 also includes a communication unit that communicates according to the same LIN communication protocol. The communication unit 116 receives information from the BCM 103 and supplies that information to the control unit 115, and also transmits information supplied from the control unit 115 to the BCM 103.

The control unit 115 outputs control signals that switch the relays in the relay box 110, namely the IG relay 11, the ACC relay 12, the reprogramming-use relay 13, and the reprogramming-use relay 14, on/off. The control unit 115 determines values of the control signals output to the relays in accordance with the relay switching commands received from the BCM 103 by the communication unit 116.

Accordingly, in the vehicle-mounted power supply system 100 according to this variation, the BCM 103 does not directly output the control signals that switch the relays in the relay box 110 on/off. Instead, the BCM 103 transmits switching commands for the relays to the relay box 110, and in response to these commands, the control unit 115 of the relay box 110 outputs the control signals that switch the relays on/off. By employing such a configuration, the only cable connecting the BCM 103 and the relay box 110 is a communication line. Therefore, a situation where an increase in the number of relays in the relay box 110 results in a corresponding increase in the number of cables can be suppressed.

### Second Embodiment

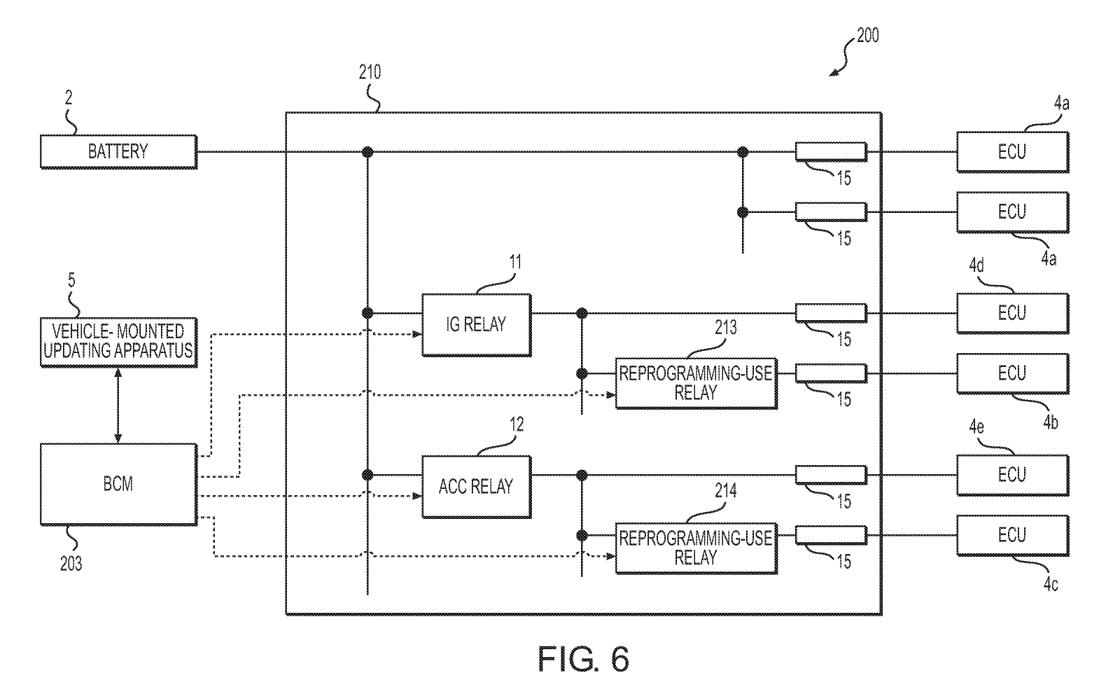

FIG. 6 is a block diagram illustrating the configuration of a vehicle-mounted power supply system 200 according to a second embodiment. In the vehicle-mounted power supply system 200 according to the second embodiment, the internal structure of a relay box 210 differs from that of the relay box 10 according to the first embodiment. Accordingly, the method by which a BCM 203 controls the relays in the relay box 210 differs as well. In the second embodiment, the relay box 210 includes four relays, namely the IG relay 11, the ACC relay 12, a reprogramming-use relay 213, and a reprogramming-use relay 214. A power supply path from the power input terminal of the relay box 210, into which power from the battery 2 is input, to the power output terminals to which the ECUs 4a, 4b, 4c, 4d, and 4e are individually connected via power lines, branch into a plurality of paths within the relay box 210. A fuse 15 is provided in each of the power supply paths from the power input terminal to the plurality of power output terminals to which the ECUs 4a are connected.

The power supply path from the power input terminal of the relay box 210 further branches into two paths. The resulting two power supply paths are connected to the IG relay 11 and the ACC relay 12, respectively. The power supply path from the IG relay 11 further branches into two paths. One of the resulting power supply paths extends to a power output terminal through a fuse 15, and an ECU 4d is connected to that power output terminal. The other resulting power supply path extends to a power output terminal through the reprogramming-use relay 213 and a fuse 15, and an ECU 4b is connected to that power output terminal.

Likewise, the power supply path from the ACC relay 12 branches into two paths. One of the resulting power supply paths extends to a power output terminal through a fuse 15, and ECUs 4e are connected to those power output terminals. The other resulting power supply path extends to a power output terminal through the reprogramming-use relay 214 and a fuse 15, and an ECU 4c is connected to that power output terminal. In the second embodiment, the ECUs 4d and 4e are ECUs that can be subject to a process for updating programs or data stored in memory.

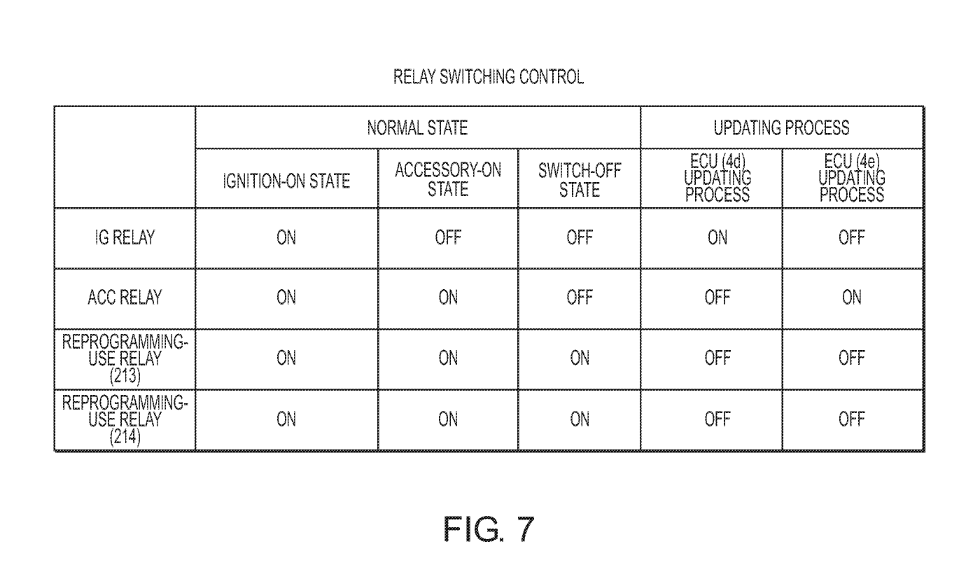

FIG. 7 is a schematic diagram illustrating switching control of each of relays in the relay box 210 by the BCM 203, according to the second embodiment. In a normal state, when the updating process is not underway, the BCM 203 according to the second embodiment controls the on/off states of the relays in the relay box 210 in response to the IG switch 1a of the vehicle 1 being operated. When the IG switch 1a is in the ignition-on state, the BCM 203 switches the IG relay 11, the ACC relay 12, the reprogramming-use relay 213, and the reprogramming-use relay 214 in the relay box 210 all on. As a result, power is supplied to all of the ECUs 4a, 4b, 4c, 4d, and 4e from the battery 2. When the IG switch 1a is in the accessory-on state, the BCM 203 turns the IG relay 11 in the relay box 210 off, and turns the ACC relay 12, the reprogramming-use relay 213, and the reprogramming-use relay 214 on. Power is supplied to the ECUs 4a, 4c, and 4e from the battery 2 as a result. If the IG switch 1a is in the switched-off state, the BCM 203 turns the IG relay 11 and the ACC relay 12 off, and turns the reprogramming-use relay 213 and the reprogramming-use relay 214 on (however, the reprogramming-use relay 213 and the reprogramming-use relay 214 may be turned off). As a result, power is supplied from the battery 2 only to the ECUs 4a, and the supply of power to the ECUs 4b, 4c, 4d, and 4e is stopped.

When the vehicle-mounted updating apparatus 5 carries out the updating process and the ECU 4d is subject to the updating process, the BCM 203 turns the IG relay 11, to which the ECU 4d is connected, on, and turns the ACC relay 12, the reprogramming-use relay 213, and the reprogramming-use relay 214 off. Likewise, when the ECU 4e is subject to the updating process, the BCM 203 turns the ACC relay 12, to which the ECU 4e is connected, on, and turns the IG relay 11, the reprogramming-use relay 213, and the reprogramming-use relay 214 off. After the BCM 203 finishes switching the relays, the vehicle-mounted updating apparatus 5 sends the update programs or data over the in-vehicle network to the ECU 4d or 4e subject to the updating process. Once the updating process is complete for the ECU 4d or 4e, the vehicle-mounted updating apparatus 5 notifies the BCM 203 that the updating process is complete. In response to this notification, the BCM 203 switches off the IG relay 11 or the ACC relay 12 that had been on. At this time, the BCM 203 may switch on the reprogramming-use relay 213 and the reprogramming-use relay 214 that had been off.

In other words, the reprogramming-use relay 213 and the reprogramming-use relay 214 are turned off when the updating process is carried out, and are turned on in the normal state, when the updating process is not underway. When the updating process is to be carried out, switching control is carried out so that only the IG relay 11 or the ACC relay 12, to which the ECU 4d or 4e subject to the updating process is connected, is turned on.

That is, assume that in a conventional vehicle, of the ECUs connected to the IG relay 11, an ECU that has no chance of being subject to an updating process is connected to the reprogramming-use relay 213 as the ECU 4b, and of the ECUs connected to the ACC relay 12, an ECU that has no chance of being subject to an updating process is connected to the reprogramming-use relay 214 as the ECU 4c. This configuration corresponds to the vehicle-mounted power supply system 200 according to the second embodiment.

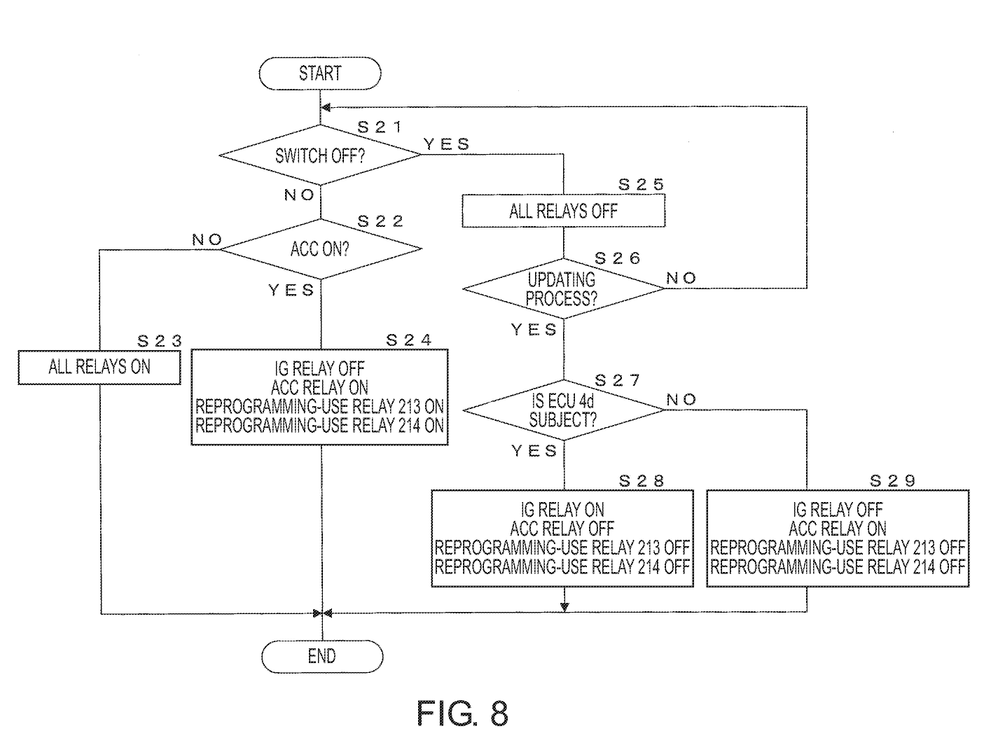

FIG. 8 is a flowchart illustrating a relay switching control processing sequence carried out by the BCM 203, according to the second embodiment. The control unit 31 of the BCM 203 according to the second embodiment determines whether or not the IG switch 1a is in the switched-off state on the basis of the state of the IG switch 1a supplied from the signal input unit 34 (step S21). If the IG switch 1a is not in the switched-off state (S21: NO), the control unit 31 furthermore determines whether or not the IG switch 1a is in the accessory-on state (step S22). If the IG switch 1a is not in the accessory-on state (S22: NO), i.e., if the IG switch 1a is in the ignition-on state, the control unit 31 outputs, from the signal output unit 35, control signals turning on each of the IG relay 11, the ACC relay 12, the reprogramming-use relay 213, and the reprogramming-use relay 214 in the relay box 210 (step S23), after which the process ends. If the IG switch 1a is in the accessory-on state (S22: YES), the control unit 31 outputs, from the signal output unit 35, control signals that turn the IG relay 11 off, turn the ACC relay 12 on, and turn the reprogramming-use relay 213 and the reprogramming-use relay 214 on (step S24), after which the process ends.

If the IG switch 1a is in the switched-off state (S21: YES), the control unit 31 outputs, from the signal output unit 35, control signals turning off each of the IG relay 11, the ACC relay 12, the reprogramming-use relay 213, and the reprogramming-use relay 214 in the relay box 210 (step S25). The control unit 31 determines whether or not the updating process is to be carried out in accordance with whether or not the in-vehicle communication unit 33 has received, from the vehicle-mounted updating apparatus 5, a notification that the updating process is to be carried out (step S26). If the updating process is not to be carried out (S26: NO), the control unit 31 returns the process to step S21.

If the updating process is to be carried out (S26: YES), the control unit 31 determines whether it is the ECU 4d that is subject to the updating process, in accordance with an updating subject notification supplied from the vehicle-mounted updating apparatus 5 (step S27). If it is the ECU 4d that is subject to the updating process (S27: YES), the control unit 31 outputs, from the signal output unit 35, control signals that turn the IG relay 11 on and turn the ACC relay 12, the reprogramming-use relay 213, and the reprogramming-use relay 214 off (step S28), after which the process ends. If it is not the ECU 4d that is subject to the updating process (S27: NO), i.e., if it is the ECU 4e that is subject to the updating process, the control unit 31 outputs, from the signal output unit 35, control signals that turn the IG relay 11 off, turn the ACC relay 12 on, and turn the reprogramming-use relay 213 and the reprogramming-use relay 214 off (step S29), after which the process ends.

The vehicle-mounted power supply system 200 according to the second embodiment configured as described above includes the IG relay 11 or the ACC relay 12 in the power supply path from the battery 2 of the vehicle 1 to the ECUs 4b to 4e, and includes the reprogramming-use relay 213 or the reprogramming-use relay 214 in the power supply path from the IG relay 11 or the ACC relay 12 to the ECU 4b or 4c, neither of which is subject to the updating process. When the vehicle-mounted updating apparatus 5 carries out the updating process for the ECU 4d or the ECU 4e, the BCM 203 turns the IG relay 11 or the ACC relay 12 on, and turns the reprogramming-use relay 213 and the reprogramming-use relay 214 off. This makes it possible to suppress a situation in which power is supplied to the ECUs 4d and 4e that are not subject to the updating process.

Although the second embodiment describes a configuration in which the BCM 203 outputs control signals that switch the IG relay 11, the ACC relay 12, the reprogramming-use relay 213, and the reprogramming-use relay 214 on/off, the configuration is not limited thereto. As with the relay box 110 described in the variation on the first embodiment, the configuration may be such that the relay box 210 according to the second embodiment is provided with a communication unit that communicates with the BCM 203, with a control unit of the relay box 210 outputting control signals that switch the relays on/off in response to switching commands transmitted from the BCM 203.

Other configurations of the vehicle-mounted power supply system 200 according to the second embodiment are the same as in the vehicle-mounted power supply system 100 according to the first embodiment. As such, parts that are the same are assigned the same reference signs, and detailed descriptions thereof will be omitted.

### REFERENCE SIGNS LIST

1 Vehicle

1a IG switch

2 Battery (power supply source)

3 BCM (relay control apparatus)

4a to 4e ECU (vehicle-mounted device)

5 Vehicle-mounted updating apparatus

10 Relay box

11 IG relay (first type of relay)

12 ACC relay (first type of relay)

13, 14 Reprogramming-use relay (second type of relay)

15 Fuse

31 Control unit (relay control unit)

32 Storage unit

32a ECU connection information

33 In-vehicle communication unit

34 Signal input unit

35 Signal output unit

100 Vehicle-mounted power supply system

103 BCM (relay control apparatus)

110 Relay box

115 Control unit (control signal output unit)

116 Communication unit

200 Vehicle-mounted power supply system

203 BCM (relay control apparatus)

210 Relay box

213, 214 Reprogramming-use relay (second type of relay)

1. (canceled)

2. A vehicle-mounted power supply system comprising:
a vehicle-mounted updating apparatus that carries out a process of updating a program or data stored in a storage device of a vehicle-mounted device mounted in a vehicle;
one or more of a first type of relay disposed in a power supply path from a power supply source mounted in the vehicle to a plurality of the vehicle-mounted devices;
one or more of a second type of relay disposed in a power supply path from the first type of relay to one or more vehicle-mounted devices that are not subject to the updating process by the vehicle-mounted updating apparatus; and
a relay controller configured to control switching of the first type of relay and the second type of relay on/off,
wherein when the vehicle-mounted updating apparatus is to carry out the updating process, the relay controller configured to:
turn the first type of relay on; and
turn the second type of relay off.

3. The vehicle-mounted power supply system according to claim 2, further comprising:
a relay box containing the first type of relay and the second type of relay.

4. The vehicle-mounted power supply system according to claim 3,
wherein the relay box includes:
a communication unit that communicates with the relay controller; and
a control signal output unit that, in response to a control command received by the communication unit from the relay controller, outputs a control signal turning the first type of relay and the second type of relay on/off.

5. (canceled)

6. A relay box comprising:
one or more of a first type of relay disposed in a power supply path from a power supply source mounted in a vehicle to a plurality of vehicle-mounted devices; and
one or more of a second type of relay disposed in a power supply path from the first type of relay to some of the plurality of vehicle-mounted devices.

7. The relay box according to claim 6, further comprising:
a communication unit that communicates with another apparatus mounted in the vehicle; and
a controller configured such that, in response to a control command received by the communication unit from the other apparatus, outputs a control signal turning the first type of relay and the second type of relay on/off.

8. (canceled)

9. A relay control apparatus comprising:
a relay controller configured to control switching one or more of a first type of relay and one or more of a second type of relay on/off, the first type of relay being disposed in a power supply path from a power supply source mounted in a vehicle to a plurality of vehicle-mounted devices, and the second type of relay being disposed in a power supply path from the first type of relay to one or more vehicle-mounted devices, among the plurality of vehicle-mounted devices, that are not subject to an updating process,
wherein when the updating process is to be carried out, the relay
controller is configured to:
turn the first type of relay on; and
turn the second type of relay off.
